(19) United States
(12) Patent Application Publication
(10) Pub. No.: US 2022/0230345 A1
(43) Pub. Date: Jul. 21, 2022

(54) IMAGE BASED MEASUREMENT ESTIMATION

(71) Applicant: Home Depot Product Authority, LLC, Atlanta, GA (US)

(72) Inventors: Estelle Afshar, Atlanta, GA (US); Yuanbo Wang, Atlanta, GA (US); Stephanie Pertuit, Atlanta, GA (US)

(21) Appl. No.: 17/152,456

(22) Filed: Jan. 19, 2021

(51) Int. Cl. G06T 7/62; G06T 7/11

(52) U.S. Cl. CPC G06T 7/62; G06T 7/11

(57) ABSTRACT

Systems and methods for providing measurement estimates for a building feature include receiving an image including the building feature. The method includes receiving, by a server, an image, the captured image including a building feature. The server locates a reference object in the image. The method includes segmenting the building feature to form a segmented image. A measurement of the building feature is estimated based on the segmented image and the reference object. The estimated measurement of the building feature is output by the server.

### FIELD

This disclosure is generally directed to measurement estimation, including systems and methods for estimating measurements of a building feature using an image of the building feature.

### BACKGROUND

Framed building features, such as, but not limited to, windows and doors, can be replaced or covered (e.g., window or door coverings such as window blinds or the like). Typically, when replacing or covering a framed building feature, measurements are taken to determine the appropriate replacement component or covering. Generally, this utilizes a process in which a retailer sends an employee to conduct measurements or an individual takes measurements. The process can be time consuming and subject to inconsistencies when different individuals complete the measurements.

### SUMMARY

Some embodiments include a method. The method includes receiving, by a server, an image, the image including a building feature. The server locates and segments a reference object in the captured image. The method includes segmenting the image including the building feature to form a segmented image. A measurement of the building feature is estimated based on the segmented image and the reference object. The estimated measurement of the building feature is output by the server.

In some embodiments, the building feature is a framed building feature.

In some embodiments, the estimated measurement includes a length and a width of the framed building feature.

In some embodiments, an error of the estimated measurement can be less than 2 inches compared to an actual measurement of the framed building feature.

In some embodiments, the reference object can be a building feature having a standard size. For example, in some embodiments, the reference object is an electrical outlet cover, a switch plate cover, a door, a ceiling height, a window sill height, or combination thereof. In some embodiments, a ceiling height can be estimated from one or more survey responses.

In some embodiments, the reference object can be any object having a standard size such as, but not limited to, a soda can, a dollar bill, or the like.

In some embodiments, a standard-sized product can be determined based on the estimated measurement. In some embodiments, the standard-sized product can include a replacement framed building feature (e.g., a replacement window or door). In some embodiments, the standard-sized product can include a covering for the framed building feature (e.g., window blinds or the like).

In some embodiments, a customized product can be determined based on the estimated measurement.

In some embodiments, an appointment for taking additional measurements can be scheduled based on the estimated measurements.

In some embodiments, an error of the measurement size can be decreased over time as additional measurement estimates are made.

Some embodiments include a server device. The server device includes a processor and a memory. The processor receives an image of a building feature and locates and segments a reference object in the image. The processor segments the image including the building feature to form a segmented image. The processor estimates a measurement of the building feature based on the segmented image and the reference object. The processor outputs the estimated measurement of the building feature.

In some embodiments, the building feature is a framed building feature.

Some embodiments include a system. The system includes a non-transitory computer-readable medium storing instructions that, when executed by a user client device, cause the user client device to receive an image of a building feature captured by a camera of the user client device, communicate with a server device to send the image to the server device, and to receive from the server device estimated measurements of the building feature and to display the estimated measurements on a display of the client device The server device is configured to receive the image from the user device, determine the estimated measurements based on a reference object in the image, the reference object being a building feature in the image having a standard size, and transmit the estimated measurements to the client device.

### BRIEF DESCRIPTION OF THE DRAWINGS

References are made to the accompanying drawings that form a part of this disclosure and that illustrate embodiments in which the systems and methods described in this Specification can be practiced.

FIG. 1 is a diagrammatic view of an example measurement estimation system, according to some embodiments.

FIG. 2 is a flowchart of a method for estimating measurements of a building feature, according to some embodiments.

FIGS. 3A-3B are schematic views showing calculation methods for estimating measurements of a building feature, according to some embodiments.

FIG. 4 is a flowchart of a method for a transaction utilizing estimated measurements of a building feature, according to some embodiments.

FIG. 5 is a flowchart of a method for estimating measurements of a building feature, according to some embodiments.

FIG. 6 is a diagrammatic view of an example user computing environment, according to some embodiments.

Like reference numbers represent the same or similar parts throughout.

### DETAILED DESCRIPTION

Building features, such as framed building features (e.g., windows), are often covered using window coverings such as, but not limited to, window blinds, drapes, or the like. To determine the appropriate measurements for the window coverings, an individual typically measures the building feature. This can result in inconsistencies based on the individual completing the measurements, and can result in errors if performed by a homeowner or other user not proficient in accurate measurements, or combinations thereof. In some cases, a customer wants a simple estimate based on approximate measurements. In such cases, the customer may not want to take the effort of completing the exact measurements for an estimate.

Embodiments described herein can utilize an image of the building feature captured by a homeowner or other user to obtain an approximate measurement for the purposes of completing an estimate. In some embodiments, the estimates may have a sufficient accuracy that the measurements from the captured image can be used to order a product. In some embodiments, a sufficient accuracy may be based on a product being ordered. That is, a sufficient accuracy may be based on a dimensional tolerance that might impact cost of a product being ordered. For example, a sufficient accuracy for flooring or molding may be +/−5 inches; +/−2 inches for shades or window coverings; and +/−1 inch for vanities, bath fixtures, and appliances. In some embodiments, machine learning can be utilized to improve the measurement accuracy over time.

Some embodiments are directed to a system and method for estimating measurements of a building feature (e.g., a framed building feature such as a window or a door) using an image of the building feature as captured by a user (e.g., using a mobile device or the like). The system identifies the estimated measurements of the building feature from the image using a reference object in the captured image. The reference object and the targeted building feature can be on any wall within the image (i.e., does not have to be on the wall including the building feature) and can be partially occluded (e.g., by curtains, blinds, etc.). Segmentation models can be trained to recognize the building feature boundaries when partially covered. In some embodiments, an accuracy of the estimated measurements can be higher if the reference object is on a same wall as the building feature. The reference object can be, for example, a building feature having a standard or otherwise known size such as, but not limited to, an electrical outlet, a light switch, a door, or the like; a height of the ceiling in the room; or a reference object having a known size (e.g., a sticker provided to the user for placement near the framed building feature prior to capturing the image). Although it is possible to use a sticker provided to the user, preference may be to avoid usage of a sticker as it requires additional actions to be taken by the user. Once the building feature is identified in the captured image, the boundaries are refined by segmenting the building feature from the captured image. The segmented building feature is then correlated to the reference object to estimate dimensions of the building feature. Estimated dimensions of the building feature are output in near real-time. In some embodiments, the estimated dimensions are within <2 inches of the actual dimensions of the building feature. In some embodiments, through machine learning, the estimated dimensions can have improved accuracy over time as additional data becomes known. That is, as additional data is available (e.g., more images of building features captured), the error will decrease.

In some embodiments, the estimation can lead to a transactional event by the user such as, but not limited to, establishing an appointment with a customer service representative, ordering of a standard-sized product (e.g., blinds, doors, etc.), or ordering of a customized product.

Embodiments described herein include reference to framed building features. It is to be appreciated that this is one example of what can be measured using the systems and methods described herein. The systems and methods herein can be applied to other features or elements within a building such as, but not limited to, any feature or element of the building that can utilize fitting dimensions. Suitable examples of other such features include, but are not limited to, appliances, bathtubs, vanities, cabinets, floor surfaces (e.g., for flooring), walls or ceilings (for paint, wallpaper, flooring, molding, combinations thereof, or the like), combinations thereof, or the like.

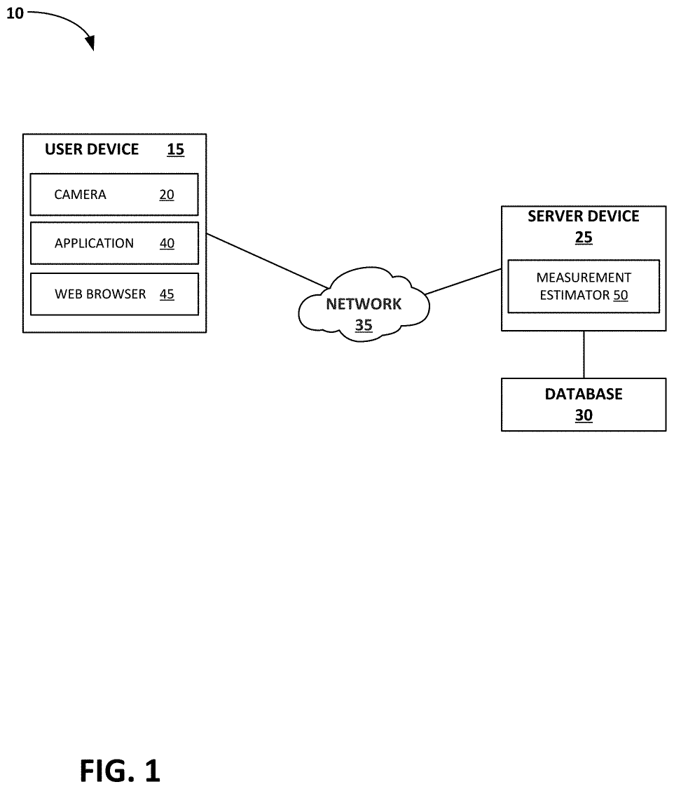

Referring to the figures, wherein like reference numerals represent the same or similar features in the various views, FIG. 1 is a diagrammatic view of an example measurement estimation system 10, according to some embodiments. The system 10 can generally be used to estimate measurements (e.g., length and width) of a building feature (e.g., a framed building feature) such as, but not limited to, a window, a door, or the like. The measurement estimation system 10 can be used to estimate the measurements of the building feature for providing an estimate of a cost to cover the building feature, to replace the building feature, to directly order the building feature or covering. In some embodiments, one or more portions of the system 10 can be implemented or provided by a retailer selling the building features, the coverings, or combinations thereof.

In the illustrated embodiment, the system 10 includes a user device 15, a server device 25, and a database 30 that are electronically communicable with one other via a network 35. It is to be appreciated that the illustration is an example and that the system 10 can vary in architecture. The system may include more than one user device 15 in communication with the server device 25 via the network 35, in some embodiments.

In the illustrated embodiment, the user device 15 includes a camera 20. The user device 15 may capture an image with the camera 20, operating under control of one or more programs executing on the user device 15. In some embodiments, the user device 15 also includes an application 40 and a web browser 45. In some embodiments, the application 40 or the web browser 45 can cause the user device 15 to transmit a captured image, data respective of the captured image, or a combination thereof, from the camera 20 to the server device 25 for measurement estimation. In some embodiments, the application 40 can be used to complete the measurement estimation instead of the server device 25. In such embodiments, a communication time for the captured image to be sent to the server device 25 can be reduced.

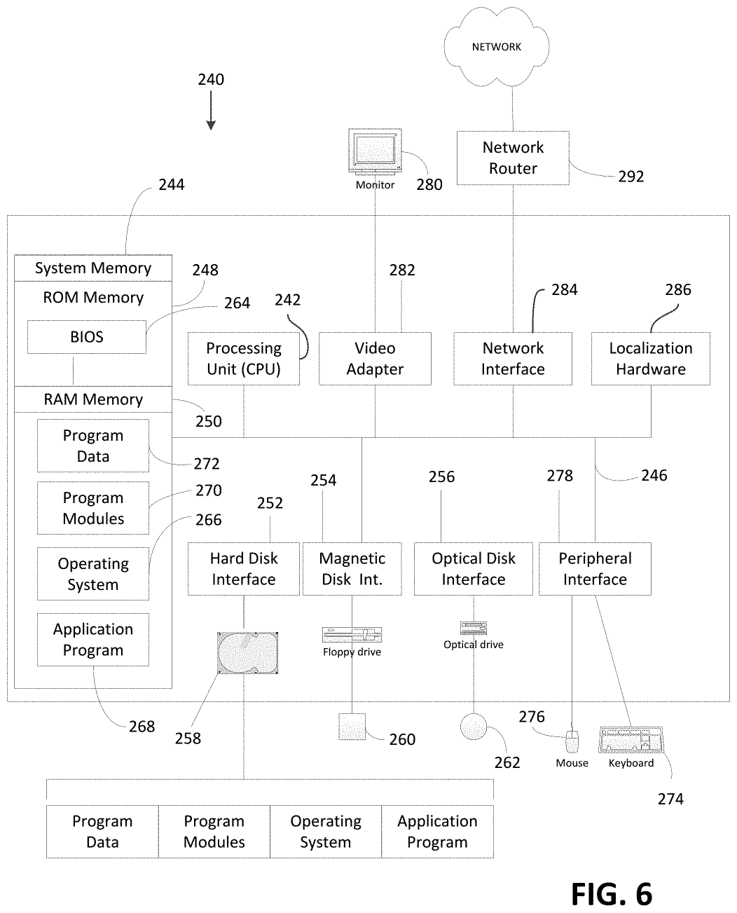

Examples of the user device 15 include, but are not limited to, a personal computer (PC), a laptop computer, a mobile device (e.g., a smartphone, a personal digital assistant (PDA), a tablet-style device, etc.), a wearable mobile device (e.g., a smart watch, a head wearable device, etc.), or the like. The user device 15 generally includes a display and an input. Examples of the display for the user device 15 include, but are not limited to, a monitor connected to a PC, a laptop screen, a mobile device screen, a tablet screen, a wearable mobile device screen, or the like. Examples of the inputs for the user device 15 include, but are not limited to, a keyboard, a mouse, a trackball, a button, a voice command, a proximity sensor, a touch sensor, an ocular sensing device for determining an input based on eye movements (e.g., scrolling based on an eye movement), suitable combinations thereof, or the like. The user device 15 can include aspects that are the same as, or similar to, FIG. 6 below.

The user device 15 includes the camera 20. In some embodiments, the camera 20 and associated programming on the user device 15 may be capable of capturing still images, video, or combinations thereof. In some embodiments, the captured image can be a still image of the building feature. In some embodiments, the camera 20 can capture an image without the user performing an action (e.g., without pressing a button) to cause the image to be captured. For example, the user may point the camera 20 in a direction of the building feature, and the user device 15 can automatically capture one or more still images for review while the user simply moves the camera 20 across the scene being captured. As used herein, a “captured image” is an image of a building feature that has been captured by the user device 15.

In some embodiments, the camera 20 can be physically separate from the user device 15, but electronically communicable with the user device 15. For example, the user can capture an image with a camera 20 and output the captured image electronically to the user device 15 for use in performing measurement estimates.

The system 10 includes the server device 25 in electronic communication with the user device 15 via the network 35. The server device 25 can include a measurement estimator 50. In some embodiments, the measurement estimator 50 can be used to analyze a captured image and estimate measurements of one or more building features within the captured image. The measurement estimator 50 may be implemented as computer-readable instructions executed by the server device 25 to perform one or more of the functions of the measurement estimator 50 described herein.

The measurement estimator 50 can identify one or more reference objects in the captured image. The reference object can include, for example, a standard sized building feature. For example, the measurement estimator may identify a reference object such as an electrical outlet cover, a switch plate cover, a door, a ceiling height, a window sill height, or combination thereof. In some embodiments, a size of a switch plate cover may vary enough that it is less suitable for use as a reference object than an electrical outlet cover or the ceiling height. In some embodiments, utilizing a reference object that is a building feature having a standard size can advantageously reduce an amount of effort required by a user in capturing the image of the building feature. That is, the user can receive instructions to capture an image that includes the building feature to be measured and that includes a portion of the floor and ceiling. This is simpler than known methods which may require the user to place a reference object near the building feature for capturing with the image of the building feature.

In some embodiments, the measurement estimator 50 can use other items as the reference object besides those identified above. For example, the reference object can include countertop height or the height of other furniture items having a generally standard height. In such embodiments, the measurement estimator 50 may utilize additional training of a machine learning algorithm to account for slight variations in height (e.g., less standard heights than ceilings or dimensions of electrical outlet covers) to achieve sufficient accuracy of the estimated measurements.

In some embodiments, a style characteristic of a building feature may provide clues as to a general construction era of the building. In such embodiments, the measurement estimator 50 correlates a ceiling height, expected window sill height, or the like, based on the typical construction practices during the construction era of the building.

In some embodiments, the application 40 or web browser 45 can display a questionnaire to the user on the user device 15. In such embodiments, the user may provide some identifying information about a ceiling height, a window sill height, a door size, an age of the home, or the like. The measurement estimator 50 can use the ceiling height, window sill height, door size, or combinations thereof, to make a correlation between the known height in the captured image and the size of the building feature. In some embodiments, the measurement estimator 50, in response to receiving an age of the home, the measurement estimator 50 can assume a particular ceiling height, door size, window sill height, electrical outlet size, switch plate size, or combinations thereof, to then correlate in the captured image relative to the building feature.

The server device 25, in addition to computing the estimated measurements based on the captured image as received and the relationship to the reference object, can determine one or more products (e.g., standard-sized products) from the database 30 based on the estimated measurements and may provide information about that product to the user device 15. In some embodiments, the user can then complete a purchase of the standard-sized product through the application 40 or the web browser 45. In some embodiments, the server device 25 can output an estimated cost of the standard-sized product. In some embodiments, the server device 25 can determine that a standard-sized product matching the estimated measurements is not available in the database 30, determine an estimated cost for ordering a customized product, and transmit the estimated cost to the user device 15.

The server device 25 can include aspects that are the same as or similar to aspects of FIG. 6 below.

In some embodiments, the network 35 can be representative of the Internet. In some embodiments, the network 35 can include a local area network (LAN), a wide area network (WAN), a wireless network, a cellular data network, combinations thereof, or the like.

The server device 25 may be in electronic communication with a database 30. The database 30 can include, among other features, a plurality of images (e.g., for training a neural network). In some embodiments, the server device 25 can include product information corresponding to building features, coverings for the building features, or combinations thereof. In some embodiments, the database 30 can include thousands of possible products orderable in conjunction with the building feature. The product information can be used, for example, to provide one or more product options to the user in response to determining the estimated measurements. The product information can include, for example, product sizes, colors, and other identifying information for products sold by a retailer.

It is to be appreciated that various roles of the server device 25 and the database 30 can be distributed among the devices in the system 10. In some embodiments, the database 30 can be maintained on the server device 25.

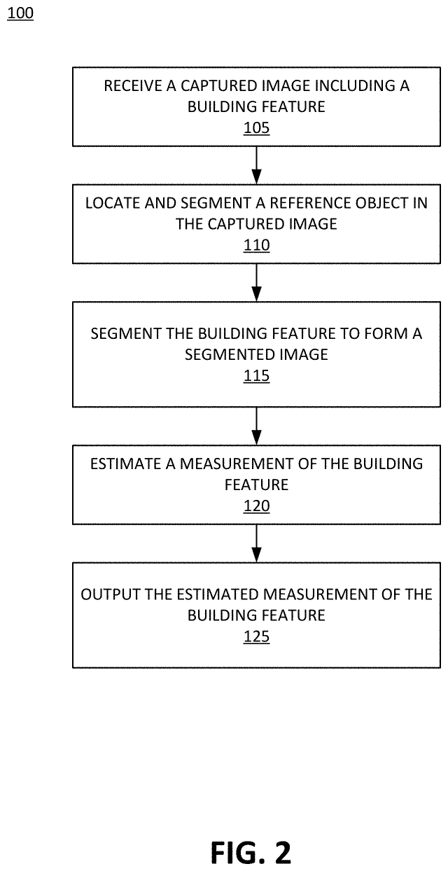

FIG. 2 is a flowchart of a method 100 for estimating measurements of a building feature, according to some embodiments.

At block 105, the method 100 includes receiving, by a server device (e.g., the server device 25 in FIG. 1), a captured image, the captured image including a building feature. The captured image may have been captured by a camera on a user device such as the camera 20 on the user device 15 (FIG. 1) and may be received from the user device. The captured image can include the building feature, one or more walls, a ceiling, and a floor. The captured image can be taken at any angle respective of the building feature. That is, the building feature may be angled with respect to the captured image. The captured image includes at least one reference object (e.g., an electrical outlet cover, a switch plate cover, a ceiling height, a door, a window sill, or combination thereof). The reference object is a building feature that is present in the building without the user placing the reference object near the building feature to be measured.

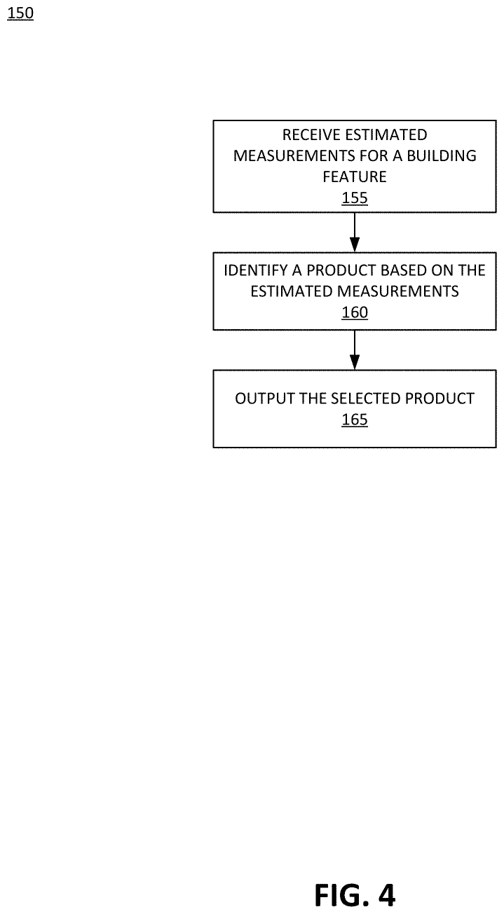

At block 110, the method 100 includes locating and segmenting a reference object in the captured image by the server device 25. It is to be appreciated that in some embodiments, the user device 15 may perform the functionality of the server device 25 (e.g., FIG. 4 below). The server device 25 can, based on known sizes of the reference object, traverse the captured image and identify objects of known size. In some embodiments, a list of objects of known size and their associated sizes may be maintained and stored so that if, during segmentation, one of the objects is identified, the size will also be known and may be retrieved. In some embodiments, if the reference object cannot be located and segmented within the captured image, then an error message may be output by the server device 25 for display on the user device 15. In some embodiments, the error message can include an instruction to the user to capture another image ensuring that at least one reference object is included within the captured image.

At block 115, the method 100 includes segmenting the image to form a segmented image by the server device 25. A “segmented image,” as used herein, includes a set of segments that are overlaid over the captured image. In some embodiments, segmenting the image can be completed using a segmenting model such as, but not limited to, Mask-RCNN, FPN, HRNet, Cascade Mask R-CNN, combinations thereof, or the like. The segmented image includes the building feature. At block 120, the method 100 includes estimating, by the server device 25, a measurement of the building feature based on the segmented image and the reference object. The reference object, having a known size, can be used to produce a relationship between the size of the reference object and the building feature. In some embodiments, the relationship can utilize both a vertical and a horizontal vanishing point. As a result, the reference object can be used as a scale to estimate the measurements of the building feature.

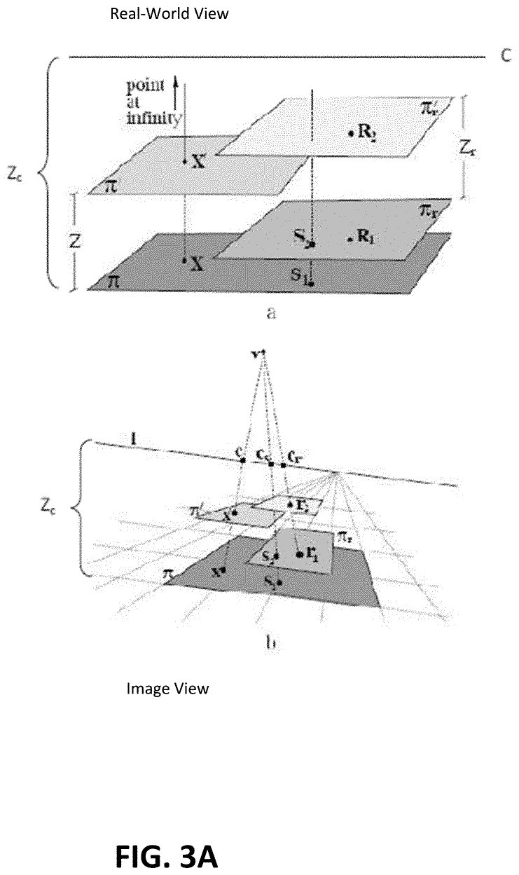

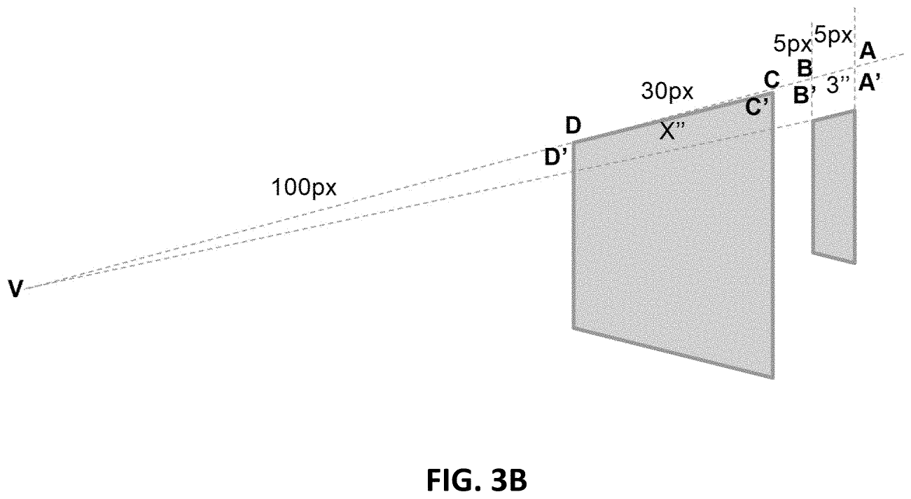

By way of example, with reference to FIG. 3A, using a height (Z) of a reference object, a height (Zr) of a building feature can be determined using the equations (1)-(3) below:

$$\begin{matrix}Zc = Z \times ( 1 - \frac{1}{crt ( x , c , {x}^{′} , v )} ) & ( 1 ) \\ s {1}_{s 2} = Z c \times ( c r t ( s2 , s 1 , cs , v ) - 1 ) & ( 2 ) \\ Zr = ( s {1}_{s 2} + Z c ) \times \frac{crt ( r 1 , cr , r 2 , v )}{crt ( r 1 , cr , r 2 ) - 1} & ( 3 )\end{matrix}$$

in which crt=cross ratio, v=vertical vanishing point, and 1=horizontal vanishing line (e.g., horizon). Utilizing the equations (1)-(3), the horizontal reference edge should be parallel with and on the same plane as the horizontal edge of the building feature.

Alternatively, with reference to FIG. 3B, the reference edge can be on a parallel plane and can be projected onto the same plane as the building feature using the following equations (4)-(5):

$$\begin{matrix}\frac{A C \times B V}{B C \times A V} = \frac{{A}^{′} {C}^{′}}{{B}^{′} {C}^{′}} = {B}^{′} {C}^{′} & ( 4 ) \\ \frac{A D \times B V}{B D \times A V} = \frac{{A}^{′} {D}^{′}}{{B}^{′} {D}^{′}} = {C}^{′} {D}^{′} & ( 5 )\end{matrix}$$

Utilizing the example numbers in FIG. 3B, the length B′C′ can be estimated to be 3.2 inches and C′D′ to be 26.2 inches.

With further reference to FIG. 2, at block 125, the method 100 includes outputting the estimated measurement of the building feature by the server device 25. In some embodiments, the server device 25 can output the estimated measurement to the user device 15 for display.

FIG. 4 is a flowchart of a method 150 for a transaction utilizing estimated measurements of a building feature, according to some embodiments.

At block 155 the method 150 includes receiving, by a user device (e.g., the user device 15 of FIG. 1) estimated measurements for a building feature from a server device (e.g., the server device 25 of FIG. 1). The estimated measurements can be computed using the method 100 of FIG. 2. At block 160, the method 150 includes identifying, by the server device 25, a product based on the estimated measurements. The product can be a product listed in the database 30 (FIG. 1). In such an embodiment, the product can include dimensions that are slightly smaller or slightly larger than the estimated measurements of the building feature, according to some embodiments. For example, in the case of window blinds, the window blinds may be a product that fits within the width of the building feature. As such, the product determined at block 160 can be a window blind having a size that is smaller than the estimated measurements. The product can be selected to have a size that is smaller, but that is relatively closest to the estimated measurements (as compared to other products within the product database 30.

At block 165, the method 150 includes outputting, by the user device 15, the selected product for display to a user.

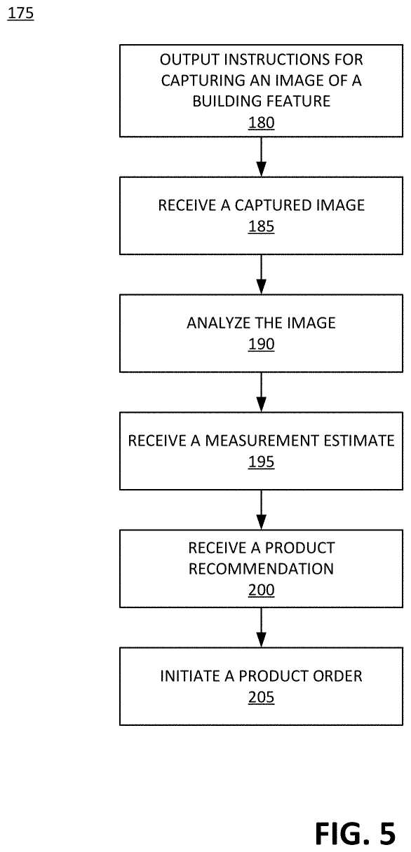

FIG. 5 is a flowchart of a method 175 for obtaining estimated measurements of a building feature, according to some embodiments.

At block 180, the method 175 includes outputting instructions to a user for contents to be included in capturing an image of a building feature to be measured. In some embodiments, the instructions can be displayed on a display of a user device (e.g., the user device 15 of FIG. 1). At block 185, the method 175 includes receiving a captured image from a camera (e.g., the camera 20 of FIG. 1) associated with the user device 15.

At block 190, the method 175 includes analyzing the image. In some embodiments, the image can be analyzed via an application (e.g., the application 40 of FIG. 1) or a web browser (e.g., the web browser 45 of FIG. 1) on the user device 20. In some embodiments, the user device 15 can transmit the captured image to a server device (e.g., the server device 25 of FIG. 1) for analysis on the server device 25 instead of on the user device 15. It is to be appreciated that the results of the analysis may be provided in a shorter processing time to the user when the analysis is performed by the application 40 or the web browser 45 relative to embodiments in which the analysis is performed by the server device 25. The analysis at block 190 can be the same as or similar to the analysis described above regarding the method 100 in FIG. 2. At block 195, the method 175 includes receiving a measurement estimate. At block 200, the method 175 includes receiving a product recommendation. In some embodiments, the application 40 can electronically communicate with the server device 25 to obtain product recommendations from a database (e.g., database 30 of FIG. 1) that are based on a size of the building feature in the measurement estimate. In some embodiments, the user may be able to order the recommended product. In such embodiments, at block 205, the method 175 includes initiating a product order. The product order can be submitted by the application 40 to the server device 25 for processing and fulfillment. In some embodiments, the user may not be able to initiate a product order through the application 40. In some embodiments, the user may instead be able to request an appointment or other consultation to complete more precise measurements. In some embodiments, a product recommendation may not be identified. In such embodiments, the user may be presented with an option to, for example, order a custom sized product based on the estimated measurements.

FIG. 6 is a diagrammatic view of an illustrative computing system that includes a general-purpose computing system environment 240, such as a desktop computer, laptop, smartphone, tablet, or any other such device having the ability to execute instructions, such as those stored within a non-transient, computer-readable medium. Furthermore, while described and illustrated in the context of a single computing system 240, those skilled in the art will also appreciate that the various tasks described hereinafter may be practiced in a distributed environment having multiple computing systems 240 linked via a local or wide-area network in which the executable instructions may be associated with and/or executed by one or more of multiple computing systems 240.

In its most basic configuration, computing system environment 240 typically includes at least one processing unit 242 and at least one memory 244, which may be linked via a bus 246. Depending on the exact configuration and type of computing system environment, memory 244 may be volatile (such as RAM 250), non-volatile (such as ROM 248, flash memory, etc.) or some combination of the two. Computing system environment 240 may have additional features and/or functionality. For example, computing system environment 240 may also include additional storage (removable and/or non-removable) including, but not limited to, magnetic or optical disks, tape drives and/or flash drives. Such additional memory devices may be made accessible to the computing system environment 240 by means of, for example, a hard disk drive interface 252, a magnetic disk drive interface 254, and/or an optical disk drive interface 256. As will be understood, these devices, which would be linked to the system bus 246, respectively, allow for reading from and writing to a hard disk 258, reading from or writing to a removable magnetic disk 260, and/or for reading from or writing to a removable optical disk 262, such as a CD/DVD ROM or other optical media. The drive interfaces and their associated computer-readable media allow for the nonvolatile storage of computer readable instructions, data structures, program modules and other data for the computing system environment 240. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 240.

Several program modules may be stored in one or more of the memory/media devices. For example, a basic input/output system (BIOS) 264, containing the basic routines that help to transfer information between elements within the computing system environment 240, such as during start-up, may be stored in ROM 248. Similarly, RAM 230, hard drive 258, and/or peripheral memory devices may be used to store computer executable instructions comprising an operating system 266, one or more applications programs 268 (such as the search engine or search result ranking system disclosed herein), other program modules 270, and/or program data 272. Still further, computer-executable instructions may be downloaded to the computing environment 260 as needed, for example, via a network connection.

An end-user may enter commands and information into the computing system environment 240 through input devices such as a keyboard 274 and/or a pointing device 276. While not illustrated, other input devices may include a microphone, a joystick, a game pad, a scanner, etc. These and other input devices would typically be connected to the processing unit 242 by means of a peripheral interface 278 which, in turn, would be coupled to bus 246. Input devices may be directly or indirectly connected to processor 242 via interfaces such as, for example, a parallel port, game port, firewire, or a universal serial bus (USB). To view information from the computing system environment 240, a monitor 280 or other type of display device may also be connected to bus 246 via an interface, such as via video adapter 282. In addition to the monitor 280, the computing system environment 240 may also include other peripheral output devices, not shown, such as speakers and printers.

The computing system environment 240 may also utilize logical connections to one or more computing system environments. Communications between the computing system environment 240 and the remote computing system environment may be exchanged via a further processing device, such a network router 292, that is responsible for network routing. Communications with the network router 292 may be performed via a network interface component 284. Thus, within such a networked environment, e.g., the Internet, World Wide Web, LAN, or other like type of wired or wireless network, it will be appreciated that program modules depicted relative to the computing system environment 240, or portions thereof, may be stored in the memory storage device(s) of the computing system environment 240.

The computing system environment 240 may also include localization hardware 286 for determining a location of the computing system environment 240. In embodiments, the localization hardware 286 may include, for example only, a GPS antenna, an RFID chip or reader, a Wi-Fi antenna, or other computing hardware that may be used to capture or transmit signals that may be used to determine the location of the computing system environment 240.

The computing environment 240, or portions thereof, may include one or more of the user device 15 and the server device 25 of FIG. 1, in embodiments.

The systems and methods described herein can advantageously ensure that B2B interactions include flexible and easy to manage security policies that are customizable by the businesses and the users accessing the computer systems of another business (e.g., a retail seller).

Examples of computer-readable storage media include, but are not limited to, any tangible medium capable of storing a computer program for use by a programmable processing device to perform functions described herein by operating on input data and generating an output. A computer program is a set of instructions that can be used, directly or indirectly, in a computer system to perform a certain function or determine a certain result. Examples of computer-readable storage media include, but are not limited to, a floppy disk; a hard disk; a random access memory (RAM); a read-only memory (ROM); a semiconductor memory device such as, but not limited to, an erasable programmable read-only memory (EPROM), an electrically erasable programmable read-only memory (EEPROM), Flash memory, or the like; a portable compact disk read-only memory (CD-ROM); an optical storage device; a magnetic storage device; other similar device; or suitable combinations of the foregoing.

In some embodiments, hardwired circuitry may be used in combination with software instructions. Thus, the description is not limited to any specific combination of hardware circuitry and software instructions, nor to any source for the instructions executed by the data processing system.

The terminology used herein is intended to describe embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A method, comprising:
receiving, by a server, an image, the image including a building feature;
locating and segmenting a reference object in the image;
segmenting the building feature to form a segmented image;
estimating a measurement of the building feature based on the segmented image and the reference object; and
outputting the estimated measurement of the building feature.

2. The method of claim 1, wherein an error of the estimated measurement is less than 2 inches.

3. The method of claim 1, comprising retrieving a standard size of the reference object; and
estimating the measurement of the building feature based on the standard size of the reference object.

4. The method of claim 3, wherein the building feature includes one of an electrical outlet cover, a switch plate cover, a ceiling, or combination thereof.

5. The method of claim 1, comprising estimating a dimension of the reference object from one or more survey responses.

6. The method of claim 1, wherein the building feature in the image is partially occluded.

7. The method of claim 1, comprising determining, based on the estimated measurement, a standard-sized product and outputting an indication of the standard-sized product with the estimate measurement.

8. A server device, comprising:
a processor and a non-transitory, computer-readable memory storing instructions;
wherein the processor executes the instructions to:
receive an image of a building feature;
locate and segment a reference object in the image;
segment the building feature to form a segmented image;
estimate a measurement of the building feature based on the segmented image and the reference object; and
output the estimated measurement of the building feature.

9. The server device of claim 8, wherein an error of the estimated measurement is less than 2 inches.

10. The server device of claim 8, wherein the processor executes instructions to retrieve a standard size of the reference object; and estimate the measurement of the building feature based on the standard size of the reference object.

11. The server device of claim 10, wherein the building feature includes one of an electrical outlet cover, a switch plate cover, a ceiling, or combination thereof.

12. The server device of claim 8, wherein the processor executes instructions to estimate a dimension of the reference object from one or more survey responses.

13. The server device of claim 8, wherein the building feature in the image is partially occluded.

14. The server device of claim 8, comprising determining, based on the estimated measurement, a standard-sized product and outputting the standard-sized product.

15. A system, comprising:
a non-transitory computer-readable medium storing instructions that, when executed by a user client device, cause the user client device to receive an image of a building feature captured by a camera of the user client device, communicate with a server device to send the image to the server device, and to receive from the server device estimated measurements of the building feature and to display the estimated measurements on a display of the client device; and
the server device, wherein the server device is configured to receive the image from the user device, determine the estimated measurements based on a reference object in the image, the reference object being a building feature in the image having a standard size, and transmit the estimated measurements to the client device.

16. The system of claim 15, wherein an error of the estimated measurement is less than 2 inches of actual dimensions of the building feature.

17. The system of claim 15, wherein the server device is configured to retrieve a standard size of the reference object; and to estimate the measurement of the building feature based on the standard size of the reference object.

18. The system of claim 15, wherein the building feature includes one of an electrical outlet cover, a switch plate cover, a ceiling, or combination thereof.

19. The system of claim 15, wherein the building feature in the image is partially occluded.

20. The system of claim 15, wherein the application is configured to estimate a dimension of the reference object from one or more survey responses.
